(19) United States
(12) Patent Application Publication
(10) Pub. No.: US 2016/0306959 A1
(43) Pub. Date: Oct. 20, 2016

(54) METHOD OF AUTHENTICATION

(71) Applicant: OUTBOUND SERVICES PTY LTD, Peregian Springs (AU)

(72) Inventor: Stewart MCDIARMID, Peregian Springs (AU)

(21) Appl. No.: 15/131,643

(22) Filed: Apr. 18, 2016

(30) Foreign Application Priority Data
Apr. 17, 2015 (AU) 2015901388

(51) Int. Cl. G06F 21/36; G06K 9/62; H04N 5/225; G06F 21/62

(52) U.S. Cl. CPC G06F 21/36; G06F 21/6218; G06K 9/6202; H04N 5/225

(57) ABSTRACT

A method of image-based authentication comprising the steps of: receiving a user input representing a first combination of a plurality of images; and performing user authentication according to a comparison of the received user input with a predetermined second combination of the images. By way of example, where a result of comparison indicates that the first combination is identical to the second combination, a user who provided the user input is successfully authenticated. Depending on the context in which the system is employed, an authenticated user may be allowed access to, for example, various services or items. Alternatively, an authenticated user may also be granted certain privileges. The method may be implemented in various security contexts requiring user authentication.

### FIELD OF INVENTION

The present invention relates to a method of authentication, more particularly to a method of image-based authentication.

### BACKGROUND ART

One aspect of conventional authentication methods involving passwords is that such passwords are generally difficult to memorise. Where the password contains only numbers, for security reasons, the password has to be relatively long in length (typically more than 8 digits). Where the password contains a combination of numbers, alphabets and symbols, although the password may be made shorter in length due to the increased number of possible combinations, alphabets and symbols may be intuitively difficult to memorise. For ease of memorisation, a password may be deliberately chosen to contain a known word (e.g. “apple” or “Mary”) or personal information (e.g. birthdays), or to be characterised by a certain pattern (e.g. “1234”). Passwords of such nature are especially vulnerable to known attack techniques, such as brute force attack and dictionary attack.

Another aspect of conventional authentication method involves the use of a physical access key or tag. However, physical keys and tags can be costly and inconvenient to replace if lost. Further, for security reasons, the corresponding lock may have to be replaced, which can be expensive and time-consuming. Moreover, physical keys and tags cannot be securely and conveniently given to a trusted party who is remotely located.

The subject matter claimed herein is not limited to embodiments that solve any disadvantages or that operate only in environments such as those described above. Rather, this background is only provided to illustrate one exemplary technology area where some embodiments described herein may be practice.

### SUMMARY OF INVENTION

The present invention provides a method of image-based authentication comprising the steps of: receiving a user input representing a first combination of a plurality of images; and performing user authentication according to a comparison of the received user input with a predetermined second combination of the images.

By way of example, where a result of comparison indicates that the first combination is identical to the second combination, a user who provided the user input is successfully authenticated. Depending on the context in which the system is employed, an authenticated user may be allowed access to, for example, various services or items. Alternatively, an authenticated user may also be granted certain privileges. The method may be implemented in various security contexts requiring user authentication.

In certain embodiments, the method may further comprise, prior to receiving the user input, the step of presenting the plurality of images. This configuration is typical of embodiments where images are to be received for presentation to a user to be authenticated. In alternative embodiments where the images are already displayed, this step may be omitted. However, it should be noted that additional images may be received for presentation in addition to images that are already displayed.

Under circumstances where a plurality of groups of images are to be presented, each group is presented in a respective time period. For example, one group may be displayed after another in the manner of a slideshow.

Preferably, the images are presented in a predetermined formation, which may, for instance, be a grid formation consisting of a number (n) of rows and a number (m) of columns, where the numbers (n) and (m) may be the same. Other formations may also be employed.

The images may be presented in a particular order or in a random order.

As alluded to above, the method may further comprise, prior to step presenting the images, the step of receiving the images according to a predetermined rule. The images may be received from a storage device, whether a local one or a remote one, which will be described in further details below. The predetermined rule may include receiving at least one image representative of at least one of a person and a geographical location. The at least one of a person and a geographical location may be predetermined. For instance, the predetermined person may be an acquaintance of a user to be authenticated, and the predetermined geographical location may be a lake to which the user has been. It can be understood that the predetermined rule may include receiving at least one image meaningful to the user but not to others. In practice, the predetermined rule may include receiving pertinent images associated with an online social network profile or any such public profile. Depending on configuration, the pertinent images may also be ones associated with a non-public, private profile. The predetermined rule may also include, for example, receiving at least one image representative of an object, an animal, or the like.

Where the images are associated with textual information corresponding to the images, the images may be presented together with such textual information.

Where the images are associated with audio information corresponding to the images, the images may be presented together with such audio information.

In embodiments involving the use of an image capture device, the user input may be received in accordance with image analysis techniques. For example, if the images are presented on a piece of paper, the image capture device may be oriented toward said piece of paper for capturing images (i.e. a video) of the to-be-authenticated user providing the user input. The captured images may be subjected to image analysis processes for determining the user input, more particularly for detecting hand movements relating to selection of the images forming the first combination.

Depending on application, the first and second combinations may contain multiple instances of a same image. In other words, the same image may form multiple portions of the combination. Preferably, successful user authentication requires the images of the combination being selected in a particular order. Put another way, the combinations may be a sequential combination.

The present invention further provides a computer readable medium comprising instructions executable by a processor for performing the steps of the method described hereinbefore.

The present invention further provides a system for image-based authentication comprising:
a processor unit; and
a storage device operatively associated with the processor unit and comprising instructions executable by the processor for performing the steps of:
   receiving a user input representing a first combination of a plurality of images; and
   performing user authentication according to a comparison of the received user input with a predetermined second combination of the images.

The processor unit may include one of a central processing unit (CPU), a microprocessor, and a combination thereof. The storage device is preferably a non-volatile storage device.

The system may further comprise a display device (e.g. a liquid crystal display (LCD) display device) operatively associated with the processor unit, wherein the storage device further comprises instructions for performing, prior to receiving the user input, the step of presenting the plurality of images on the display device. The display device may be one associated with an intercom unit. The above descriptions of image presentation in relation to the method and the computer readable medium are applicable to the system. Alternatively, some or all of the other components may be associated with the intercom unit.

The storage device may further comprise instructions for performing, prior to presenting the images, the step of receiving the images according to a predetermined rule. In one exemplary embodiment, the system may further comprise a network interface operatively associated with the processor unit and through which the processor unit receives the images. This configuration may be useful where the images are not stored in the storage device. The above descriptions of the predetermined rule for receiving at least one image are also applicable to the system, so are the above descriptions of the textual and audio information to be presented together with the images. Where audio information is to be presented, the system may further comprise an audio reproduction unit operatively associated with the processor unit for audibly reproducing the audio information.

The display device may be a touchscreen display device on which the images are presented and from which the user input is received. However, where the display device is not a touchscreen display device, other input peripheral devices may be required, such as a mouse pointer device or a keypad.

The system may further comprise an image capture device operatively associated with the processor unit, wherein the storage device further comprises instructions for receiving the user input from the image capture device using image analysis techniques. As suggested above, this arrangement may be useful in embodiments where the images are printed on a piece of paper. In a practical scenario, the image capture device and the audio reproduction unit may be provided at a residential premise while the other components may be provided at another location (e.g. a central surveillance office), in which the image capture device may be operatively associated with the processor via a network, such as the Internet. At the surveillance office, upon receipt of images of the user providing the user input, the processor may be operable to store the received images in the storage device or another storage device. The processor may further present the received images on a display device, enabling surveillance by security personnel. The system may be configured to cooperate with or to implement further security functions for detecting abnormalities, such as vandalisms, intrusions or the like.

It should be noted that other electronic devices suitable for capturing the user input may also be adopted in substitution for or in addition to the image capture device. Also, more than one image capture devices may be employed for increased accuracy or additional functions (e.g. object depth detection).

As suggested above, each of the combinations may be a sequential combination. Alternatively, the user input may simply present the number of times each image is selected, and the user is authenticated if the number of times each image is selected corresponds to a predetermined setting.

The present invention further provides a method of image-based authentication comprising the steps of:
receiving, using an image capture device, an image from a user;
identifying, from the captured image, a predetermined feature; and
authenticating the user according to a result of identifying the predetermined feature.

In certain implementations, the predetermined feature is not a facial feature.

The present invention further provides a method of image-based authentication comprising the steps of:
receiving, using an image capture device, a sequence of images from a user; and
authenticating the user according to a comparison of a predetermined sequence and the sequence in which the images are received.

The above methods may be useful in overcoming or alleviating, among others, the abovementioned drawbacks of the prior art, namely the need for a physical key or tag. In particular, the predetermined feature or the predetermined sequence may be easily changed by, for example, software re-configuration, and may be provided to a trusted person via any suitable electronic means.

### BRIEF DESCRIPTION OF ACCOMPANYING DRAWINGS

To further clarify various aspects of some embodiments of the present invention, a more particular description of the invention will be rendered by references to specific embodiments thereof, which are illustrated in the appended drawings. It is appreciated that these drawings depict only typical embodiments of the invention and are therefore not to be considered limiting of its scope. The invention will be described and explained with additional specificity and detail through the accompanying drawings in which:

FIG. 1 shows a schematic block diagram of a system of the present invention in relation to a network and a database;

FIG. 2 shows six exemplary portrait images for the purpose of image-based authentication according to the present invention; and

FIG. 3 shows the portrait images in different groups for presentation at respective time periods.

### DETAILED DESCRIPTION OF THE PREFERRED EMBODIMENTS

The present invention provides a method, a computer readable medium, and a system for imaged-based authentication. Hereinafter, this specification will describe the present invention according to the preferred embodiments. It is to be understood that limiting the description to the preferred embodiments of the invention is merely to facilitate discussion of the present invention and it is envisioned without departing from the scope of the appended claims.

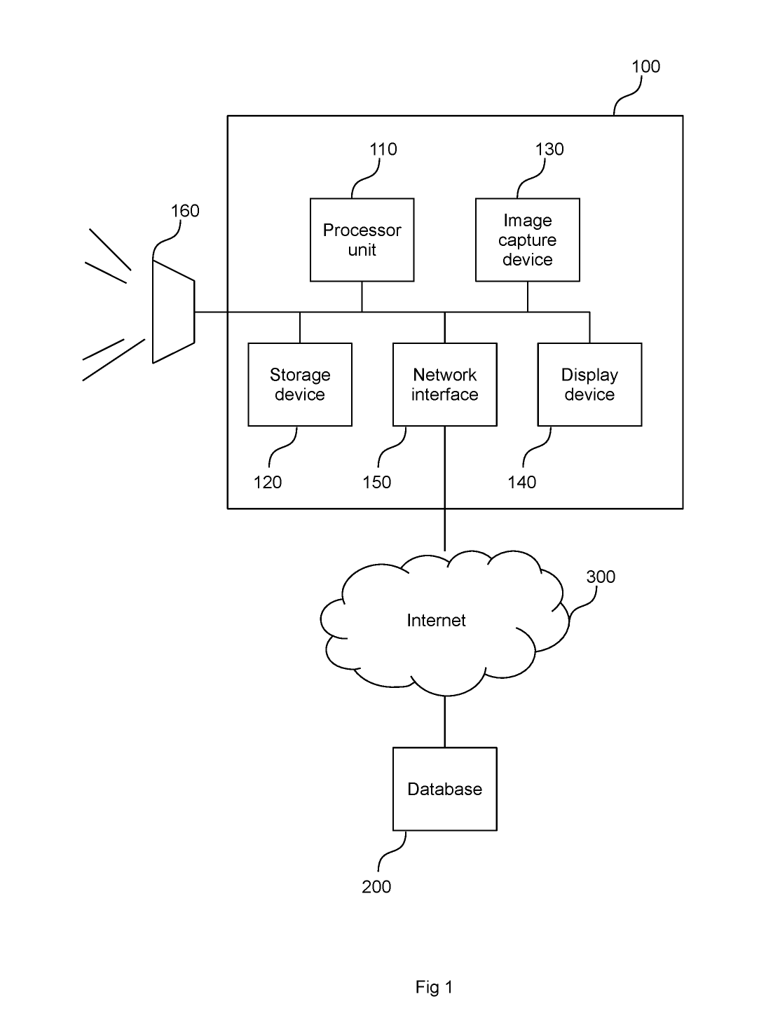

As shown in FIG. 1, the first preferred embodiment of a system 100 for image-based authentication according to the present invention includes a processor unit 110, a storage device 120 and an image capture device 130. The processor unit is operatively associated with the other electronic components 110, 120.

The storage device 120 includes a computer readable medium with instructions executable by the processor unit 110 for performing a method of image-based authentication according to the present invention so as to authenticate a user. The method includes the consecutive steps of:
a1) receiving a user input representing a first combination of a plurality of images; and
a2) performing user authentication according to a comparison of the received user input with a predetermined second combination of the images.

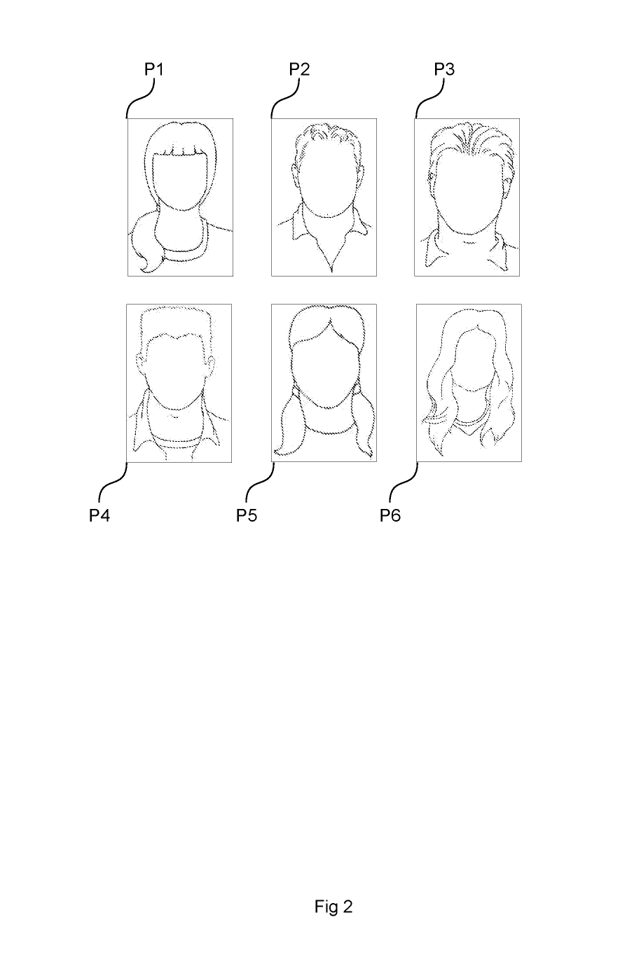

The image capture device 130 is oriented toward a piece of paper on which the images are shown (see FIG. 2) for capturing images (i.e., a video) of the user providing the first combination. In the exemplary scenario of this embodiment, the images P1-P6 show different persons, respectively, some of whom may be known by a user to be authenticated. In this example, persons corresponding to images P1, P3 and P5 are known by the user. The system is configured such that the second combination consists of the sequence of “P1→P3→P5→P1→P1”. In this embodiment, the images are arranged in a grid formation and are sorted in a random order.

In step a1), the processor unit 110 receives the user input from the image capture device using image analysis techniques. Specifically, the captured images are subjected to image analysis processes for determining the user input, more particularly for detecting hand movements relative to the images on the piece of paper. Such hand movements may include tapping, clicking and pointing.

In step a2), the processor unit 110 compares the first combination represented by the user input with the second combination, and authenticates the user if the first and second combinations are identical.

The second preferred embodiment differs from the first embodiment in that, in the second preferred embodiment, the system 100 further includes a display device 140 operatively associated with the processor unit 110. The storage device 120 has further stored therein image data representing the images and instructions for performing, prior to receiving the user input, the step of b1) presenting the plurality of images on the display device. Specifically, in step b1), the processor unit 110 renders a visual representation of the image data in the storage device 120 for display on the display device 140. Where the display device 140 is a touchscreen device, the user is able to provide the user input using the touchscreen device. That is, the user input is received from the touchscreen device. Otherwise, peripheral input devices may be provided for receiving the user input.

The third preferred embodiment differs from the second embodiment in that, in the third preferred embodiment, the system further includes a network interface 150 operatively associated with the processor unit 110. The storage device 120 has further stored therein instructions for performing, prior to presenting the images, the step of receiving the images via the network interface 150 according to a predetermined rule. The network interface 150 is operatively associated with a database device 200 via a network 300 (e.g., the Internet), where the database device 200 presents a source of the images. In this embodiment, the storage device 120 may or may not have stored therein some or all of the images. In this embodiment, the images are received by the system 100 from the database device 200 via the network 300.

The predetermined rule includes receiving a plurality of image representative of a plurality of predetermined persons, these persons being persons known by the user whose portraits are shown in images P1, P3 and P5. Alternatively, as suggested hereinabove, images of other objects, geographical locations and animals recognisable by the user may also be used.

The fourth preferred embodiment differs from the third preferred embodiment in that, in the fourth preferred embodiment, the system 100 further includes an audio reproduction unit 160 operatively associated with the processor unit 110, and the storage device has further stored therein textual and audio information relating to the images and instructions for presenting the textual information together with the images on the display device 140 and for rendering an audible reproduction of the audio information using the audio reproduction unit 160.

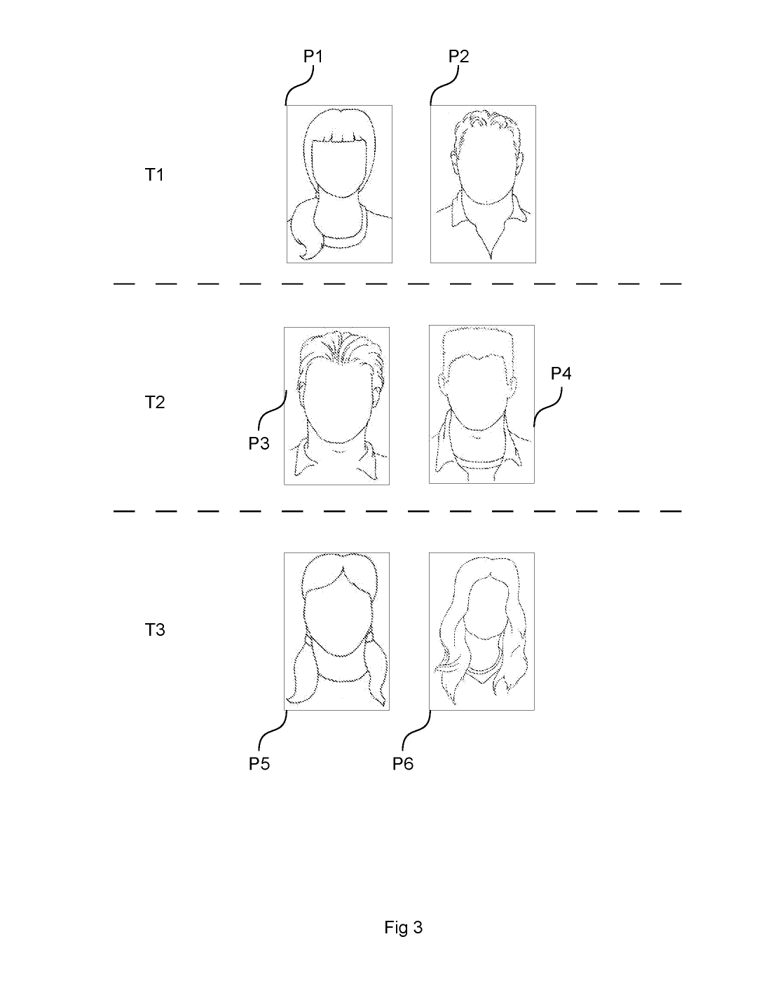

In an exemplary alternative arrangement as illustrated in FIG. 3, the images P1-P6 are divided into three groups G1-G3, each group G1-G3 being presented on the display device 140 in a respective one of temporally consecutive time periods.

Unless the context requires otherwise or specifically stated to the contrary, integers, steps or elements of the invention recited herein as singular integers, steps or elements clearly encompass both singular and plural forms of the recited integers, steps or elements.

Throughout this specification, unless the context requires otherwise, the word “comprise”, or variations such as “comprises” or “comprising”, will be understood to imply the inclusion of a stated step or element or integer or group of steps or elements or integers, but not the exclusion of any other step or element or integer or group of steps, elements or integers. Thus, in the context of this specification, the term “comprising” is used in an inclusive sense and thus should be understood as meaning “including principally, but not necessarily solely”.

It will be appreciated that the foregoing description has been given by way of illustrative example of the invention and that all such modifications and variations thereto as would be apparent to persons of skill in the art are deemed to fall within the broad scope and ambit of the invention as herein set forth.

1. A method of image-based authentication comprising the steps of:
receiving a user input representing a first combination of a plurality of images; and
performing user authentication according to a comparison of the received user input with a predetermined second combination of the images.

2. The method as claimed in claim 1, further comprising, prior to receiving the user input, the step of presenting the plurality of images.

3. The method as claimed in claim 2, wherein each group of the images is presented in a respective time period or the images are presented in a predetermined formation, such as a grid formation or the images are presented in a random order.

4. The method as claimed in claim 2, further comprising, prior to step presenting the images, the step of receiving the images according to a predetermined rule, the predetermined rule preferably including receiving at least one image representative of at least one of a person and a geographical location, more preferably the at least one of a person and a geographical location being predetermined.

5. The method as claimed in claim 2, wherein the images are presented together with textual information corresponding to the images or the images are presented together with audio information corresponding to the images.

6. The method as claimed in claim 1, wherein the user input is received in accordance with image analysis techniques and/or each of the first and second combinations is a sequential combination.

7. A computer readable medium comprising instructions executable by a processor for performing the steps of:
receiving a user input representing a first combination of a plurality of images; and
performing user authentication according to a comparison of the received user input with a predetermined second combination of the images.

8. The computer readable medium as claimed in claim 7, further comprising instructions for performing, prior to receiving the user input, the step of presenting the plurality of images.

9. The computer readable medium as claimed in claim 8, wherein each group of the images is presented in a respective time period or the images are presented in a predetermined formation, preferably a grid formation, or the images are presented in a random order.

10. The computer readable medium as claimed in claim 7, further comprising instructions for performing, prior to presenting the images, the step of receiving the images according to a predetermined rule, preferably the predetermined rule including receiving at least one image representative of at least one of a person and a geographical location, more preferably the at least one of a person and a geographical location being predetermined.

11. The computer readable medium as claimed in claim 7, wherein the images are presented together with textual information corresponding to the images.

12. The computer readable medium as claimed in claim 7, wherein the images are presented together with audio information corresponding to the images or the user input is received in accordance with image analysis techniques.

13. The computer readable medium as claimed in claim 7, wherein each of the first and second combinations is a sequential combination.

14. A system for image-based authentication comprising:
a processor unit; and
a storage device operatively associated with the processor unit and comprising instructions executable by the processor for performing the steps of:
receiving a user input representing a first combination of a plurality of images; and
performing user authentication according to a comparison of the received user input with a predetermined second combination of the images.

15. The system as claimed in claim 14, further comprising a display device operatively associated with the processor unit, wherein the storage device further comprises instructions for performing, prior to receiving the user input, the step of presenting the plurality of images on the display device.

16. The system as claimed in claim 15, wherein each group of the images is presented in a respective time period or the images are presented in a predetermined formation, such as a grid formation, or the images are presented in a random order.

17. The system as claimed in claim 15, wherein the storage device further comprises instructions for performing, prior to presenting the images, the step of receiving the images according to a predetermined rule.

18. The system as claimed in claim 17, further comprising a network interface operatively associated with the processor unit and through which the processor unit receives the images.

19. The system as claimed in claim 17, wherein the predetermined rule includes receiving at least one image representative of at least one of a person and a geographical location, preferably wherein the at least one of a person and a geographical location is predetermined.

20. The system as claimed in claim 15, wherein the images are presented together with textual information corresponding to the images.

21. The system as claimed in claim 15, further comprising an audio reproduction unit operatively associated with the processor unit, wherein the images are presented together with audio information corresponding to the images, the audio information being audibly reproduced using the audio reproduction unit.

22. The method as claimed in claim 15, wherein the display device is a touchscreen display device from which the user input is received.

23. The system as claimed in claim 14, further comprising an image capture device operatively associated with the processor unit, wherein the storage device further comprises instructions for receiving the user input from the image capture device using image analysis techniques.

24. The system as claimed in claim 14, wherein each of the first and second combinations is a sequential combination.
